(19) United States
(12) Patent Application Publication
(10) Pub. No.: US 2003/0049433 A1
(43) Pub. Date: Mar. 13, 2003

(54) Multilayered composite resistant to HFC245fa

(76) Inventor: Terry L. Virkler, Ellington, CT (US)

Correspondence Address: BAYER CORPORATION, PATENT DEPARTMENT, 100 BAYER ROAD, PITTSBURGH, PA, 15205, US

(21) Appl. No.: 09/941,093

(22) Filed: Aug. 28, 2001

(51) Int. Cl. B32B 3/26

(52) U.S. Cl. 428/319.1; 428/319.3

(57) ABSTRACT

A multilayered structure comprising, in sequence, an ABS layer, a foamed polyurethane layer and a constraining layer the layers adhering one to the other is disclosed. This composite structure that entails a constrained ABS layer that contains specific additives, and a foamed polyurethane layer that was foamed by 1,1,1,3,3-pentafluoropropane, is characterized by its exceptional resistance to thermal cycling and is therefore suitable for refrigeration purposes.

### FIELD OF THE INVENTION

The present invention relates to a composite, multilayered structure suitable for refrigeration applications, more particularly the invention concerns a structure that contains a layer of grafted rubber, a layer of 1,1,1,3,3 pentafluoropropane-foamed polyurethane and a constraining layer.

1. Summary of the Invention

A multilayered structure comprising, in sequence, an ABS layer, a foamed polyurethane layer and a constraining layer the layers adhering one to the other is disclosed. This composite structure that entails a constrained ABS layer that contains specific additives, and a foamed polyurethane layer that was foamed by 1,1,1,3,3 pentafluoropropane, is characterized by its exceptional resistance to thermal cycling and is therefore suitable for refrigeration purposes.

2. Description of the Prior Art

Composite structures comprising cellular insulation material that is bonded to a thermoplastic sheet are known. The insulation material is commonly prepared by foaming-in-place techniques. The resulting composite structure is used in a wide variety of applications where insulation, particularly thermal insulation, is required. Of particular interest is the use of these structures in the construction of panels, such as door panels in refrigerators. In these applications, the thermoplastic sheet is presented as the exterior surface of the composite while the cellular insulation material is hidden from view by a constraining panel. In such composites polyurethane foam is used as the cellular insulation material and acrylonitrile-butadiene-styrene (ABS) polymer is used as the thermoplastic sheet material.

The insulating polyurethane is characterized in that its cells contain at least residuals of the foaming agent in the form of chlorofluorocarbon gas (CFC). Due to environmental considerations relating to the depletion of the ozone layer, these have later being replaced by hydrogenated compounds, i.e. hydrofluorocarbons (HFC). While these may be more environmentally friendly, HFC are more aggressive towards ABS resins. The loss of mechanical properties of ABS, notable the tendency to crack, in connection with the use of gas-filled foam has long been recognized and a varieties of solution have been presented, see for instance “HCFC Blown Rigid Polyurethane Foams and Refrigerator Liner Materials: The Search for Compatible Systems” by K. G. Potter and C. R. Tweedale-Polyurethane World Congress 1991—Sep. 24-26, 1992, pages 560-570. U.S. Pat. No. 5,409,774 is noted to have disclosed a composite structure useful in corresponding applications, containing ABS and HCFC-foamed polyurethane.

A particularly desirable foaming agent is 1,1,1,3,3 pentafluoro-propane, also known as HFC245fa presented a technical challenge to the producers of ABS sheet materials. It became apparent that while meeting environmental and insulation requirements, the thus foamed material is not completely compatible with ABS especially at the environment that the composite is destined to be used, where it needs to withstand severe thermal cycling.

### DETAILED DESCRIPTION OF THE INVENTION

ABS as the term is used in the present context is a well-known material system. U.S. Pat. Nos. 4,713,420; 4,430,478; 4,277,574; 4,017,559 ; 3,931,356 ; 3,928,495; 3,905,238; 3,905,237 ; 3,903,200; 3,903,199; 3,825,621; 3,663,656; 3,652,721; and 3,576,910 are all incorporated herein by reference for their relevant disclosure of this material system.

Rubber particle size reported herein was determined in a manner disclosed in Hoffman, An Improved Technique for Particle Size Measurement, Journal of Colloid and Interface Science, Vol. 143, No. 1 (April 1991). The instrument used to determine particle size was a Horiba centrifugal particle size distribution analyzer, Model CAPA 500. The Horiba centrifuge disk was operated at 480 rpm to measure larger particles and at higher speeds to measure smaller particles. The rubber particles were dispersed at 5 to 10 weight percent of the ABS to be measured in propylene carbonate. The rubber phase particle size is reported as weight average diameter (Dw), in microns.

The ABS Layer:

In a one embodiment of the invention, the ABS layer comprise a grafted rubber (herein first grafted rubber), a matrix (first matrix) and an additive (first additive).

The ABS of the present invention may be prepared by any of the methods which are well known to those skilled in the art. The polymerization processes and their respective particle size are likewise well known. The ABS is preferably prepared by polymerizing the styrene and acrylonitrile monomers in the presence of the rubber by suspension, bulk or mass polymerization methods. In particular, a preformed rubber substrate is dissolved in at least a portion of the monomers which form the grafted phase and the copolymeric matrix and the solution is polymerized so that at least a portion of the monomers are combined chemically or grafted onto the rubber substrate and a portion form ungrafted matrix. Alternatively, the graft polymerization may be carried out so as to form occlusions of the styrene acrylonitrile copolymer in the rubber particles of the graft base. Depending upon the ratio of monomers to rubber graft base and polymerization conditions, it is possible to produce rubbers or predetermined particle size as is well known to the art-skilled. Blends of two or more ABS components may be used to prepare the ABS layer of the invention.

The first grafted rubber contains a first graft base and a first grafted phase. The graft base is a (co)polybutadiene rubber, namely a homopolymeric polybutadiene or a copolymer thereof. Stated otherwise, the graft base is a rubber wherein at least 70, preferably 90 to 100 mole % of the structural units are derived from butadiene. Comonomers, in amounts of up to 30 mole percent, such as isoprene, styrene, acrylonitrile or chloroprene, preferably acrylonitrile may be used in the preparation of the graft base.

The first grafted phase comprises a copolymer of styrene and acrylonitrile. About 20 to 34, preferably 24 to 30 percent of the structural units of this copolymer are derived from acrylonitrile, the percent being relative to the total weight of the structural units of this copolymer that are derived from styrene and acrylonitrile. The copolymer may include additional structural units that are derived from other monomers including alpha methyl styrene and halogenated styrene, and methacrylonitrile as well as acrylate, preferably butyl-acrylate. These comonomers may be present in amounts not exceeding 20%, preferably not exceeding 5% relative to the weight of the copolymer.

The first matrix contains a copolymer (referred to herein as first matrix copolymer) of styrene and acrylonitrile. This first matrix copolymer is characterized in that its molecular weight (number average) is greater than 65, preferably 70 to 90 kg/mole, and in that its structural units contain 20 to 34, preferably 26 to 32 percent of units derived from acrylonitrile, the percent being relative to the total weight of the units that are derived from styrene and acrylonitrile. The first matrix copolymer may further include units derived from other monomers, including methacrylonitrile, styrene and alpha methyl styrene and acrylate, preferably methacrylate or butyl acrylate. These comonomers may be present in amounts not exceeding 20%, preferably not exceeding 5% relative to the weight of the copolymer.

The first additive is at least one member selected from the group consisting of (1) bisamide wax preferably bis-stearamide in an amount of at least 2 preferably 3 to 4 percent by weight and (2) di-alkyl siloxane in an amount of at least 0.1, preferably 0.15 to 0.25 percent by weight, the percents referring to both wax and bisamide are in relation to the weight of the ABS layer.

Suitable bisamide wax is Acrawax, a commercial product of Lonza. The dialkyl siloxane, preferably dimethyl polysiloxane, is characterized in that its viscosity is 10 to 10,000,000 centistokes, preferably 1000 to 10,000 centistokes. A suitable siloxane is available commercially from Dow Corning as 200 Fluid.

Further, the amount of graft base, (co)polybutadiene rubber in this one embodiment is about 10 to 20, preferably 13 to 17 percent relative to the weight of the ABS layer. In a second embodiment of the invention, the ABS layer comprise grafted rubber and a matrix and an additive (referred to below respectively as second grafted rubber, second matrix and second additive).

The second grafted rubber contains a graft base (second graft base) and a grafted phase (second grafted phase). The second graft base is a (co)polybutadiene rubber, namely a homopolymeric polybutadiene or a copolymer thereof. Stated otherwise, the graft base is a rubber wherein at least 70, preferably 90 to 100 mole % of the structural units are derived from butadiene. Comonomers, such as isoprene styrene, acrylonitrile and or chloroprene, preferably acrylonitrile, in amounts of up to 30 mole percent, such as may be used in the preparation of the second graft base. The second graft base is further characterized in that is particle size is at least 2, preferably 3 to 5 microns, the particle size being determined as weight average particle diameter in accordance with the method described above.

The second grafted phase comprise a copolymer of styrene and acrylonitrile containing 20 to 34, preferably 24 to 30 percent of structural units derived from acrylonitrile, the percent being relative to the total weight of the structural units of this copolymer that are derived from styrene and acrylonitrile. This copolymer too may include additional structural units that are derived from other monomers, including methacrylonitrile, alpha methyl styrene, chlorinated styrene, and (meth)acrylate, preferably butyl acrylate. These comonomers may be present in amounts not exceeding 20%, preferably not exceeding 5% relative to the weight of the copolymer.

The second matrix contains a copolymer of styrene and acrylonitrile having a number average molecular weight greater than 55, preferably 60 to 70 kg/mole, the molecular structure of the copolymer including 20 to 34, preferably 26 to 32 percent of units derived from acrylonitrile, the percent being relative to the total weight of the structural units of this copolymer that are derived from styrene and acrylonitrile. The copolymer may also include structural units derived from methacrylonitrile, α-methyl styrene, chlorinated styrene, and acrylates, preferably methacrylate or butyl acrylate. These comonomers may be present in amounts not exceeding 20%, preferably not exceeding 5% relative to the weight of the copolymer. The second additive is a dialkyl siloxane that is present in an amount of at least 0.1, preferably 0.15 to 0.25 percent by weight relative to the weight of the ABS layer. The dialkyl siloxane has been described above. Further, the amount of graft base, (co)polybutadiene rubber in the second embodiment is about 10 to 20, preferably 13 to 17 percent relative to the weight of the ABS layer.

The Foamed Polyurethane Layer:

The cellular material used in the composites of the present invention is polyurethane foam that (i) has been prepared by using 1,1,1,3,3-pentafluoropropane, also known as HFC 245fa as the foaming agent and (ii) has a density of about 1.5 to 3 lb/ft³ and (iii) thermal conductivity that is no greater than 0.2 BTU-in/hr ft² F. Preferably, the polyurethane foam thus prepared has a density of 1.5 to 2.5 lb/ft³ and thermal conductivity that is 0.1 to 0.15 BTU-in/hr ft² F. The suitable polyurethane is a well-known material. A description of polyurethane, the raw materials for its preparation and the methods therefor have been widely described in the literature, including “Polyurethane Handbook, by Gunther Oertel, Hanser Publishers, 1985, that is incorporated herein by reference.

Foaming of the suitable polyurethane is attained by using about 8 to 15, preferably 10 to 15 percent of 1,1,1,3,3 pentafluoropropane, HFC245 fa, the percent being relative to the weight of the polyurethane to be foamed.

As is well known, the cells of the foamed polyurethane contain at least residual amounts of the foaming agent or else the foaming agent is deliberately placed in the cells to enhance the thermal insulation properties of the cellular material.

The foam layer of the inventive composite is usually prepared by foaming-in-place techniques. This involves positioning the other layers in a suitable jig or mold. A foamable mixture is then introduced in the space between the layers. The resulting foam adheres to the surfaces of the constraining layer and the ABS layer to provide an integral composite structure. The foam may be cured by conventional heating methods or by infrared or microwave heating methods. The foam bonds to the inside of the exterior portion and the LR ABS surface of the composite during this process and secures them in the spaced relationship thereby enabling a rigid structure of high strength to be obtained.

The technique used for filling the space can be any of the conventional techniques used for filling spaces and voids in-situ. Examples of suitable compositions and techniques are described in “Rigid Plastic Foams” by T. H. Ferrigno, published by Reinhold Publishing Corp., second edition, 1967, pages 1-206, incorporated herein by reference. Alternately, the foam can be laminated to layers using suitable adhesives or melt adhesion techniques.

The bond strengths of the foam to the LR ABS should be such that the SR ABS/LR ABS/foam composites maintain its integrity without any substantial separation of the respective components.

The Constraining Layer:

The constraining layer of the invention is preferably a sheet having physical dimensions and constructed of a material, such as metal, plastic and ceramics, the material parameters of which are calculated to impart to the ABS layer a stress level of at least 1000, preferably 1500 to 2500 psi. In a preferred embodiment, the sheet is of aluminum or steel.

Preferably, the thickness of the inventive composite structure is in the range of from about 500 to 3200 mils. The thicknesses of the layers are in the range of 10 to 200 mils, preferably 30 to 100 mils for the ABS Layer, 300 to 3000 mils, preferably 1500 to 2500 mils for the Polyurethane Foam Layer, and 10 to 100 mils, preferably 20 to 40 mils for the Constraining Layer.

The several layers making up the inventive composite should have a bond strength therebetween sufficient to enable the composite to maintain its integrity during the construction operation, e.g., handling, assembly, foaming-in-place and thereafter without any substantial separation.

To simulate the stress and environmental demands placed on liner materials in an actual refrigerator, a prototype was constructed with an actual foodliner mullion in the thermoforming design. The mullion is the section of the liner between the food section and the freezer section of a refrigerator, an area of high thermal stress. The mullion section contains small radii or curvature and geometry changes such as to result in imparting a stress level of at least 1000 psi, preferably about 1000 to 2000 psi in at least one portion of the ABS layer in the course of thermal cycling. The prototype test consists of thermoforming the specimen such as an ABS layer measuring about 12 by 24 inches and having a thickness of 100 mils+/−2 mils and with orientation in the machine direction as measured by oven shrinkage of less than 20%. The forming is heated to about 50° C. along with the prototype fixture, and securing the forming to the fixture with bolts and serrated clamps while both are at that temperature. The fixture consists of an aluminum box open on one face. The polyurethane foam component containing HFC245fa blowing agent was then introduced. The prototype is then cooled to room temperature. The prototype was then subjected to thermal cycling as described below: After the PU foam has cured (over a 2 hours period) the assembly was allowed to equilibrate for 24 hours at 73° F. and then cooled to −40° F. over a period of 6-8 hours and held for the reminder of a 12 hour overall time span. The assembly was then heated to 140° F. over a period of 4-6 hours and held for the remainder of an overall time span of 12 hours. The cycle was repeated until a first crack forms. The precision of the mean for this test, using constant PU foam and ABS formulations, and using at least 6 replicates for each test, is a standard deviation of 1.5 cycles

### EXAMPLES

The following examples are set forth in illustration of the present invention and are not to be construed as a limitation thereof. Unless otherwise indicated all parts and percentages are by weight.

In each example below the ABS layer, containing conventional additives having no criticality in the present context, was thermoformed and assembled as noted above by attachment to an aluminum constraining layer. Polyurethane foam was introduced using 14.5 weight % HFC245fa as the blowing agent and achieving a foam with a density of 1.83-2.15 lb/ft³, and a thermal conductivity of 0.13-0.14 BTU-in/hr ft² F. The assemblies were thermally cycled as noted above.

The bis-amide used in the examples was Acrawax. The siloxane was dimethyl polysiloxane a product of Dow Corning. In all of the examples, except Example 7, the ABS material was a blend of mass suspension and emulsion ABS. The ABS material of Example 7 was an emulsion product.

The criterion of success was determined as more then 10 thermal cycles.

The table below summarizes the results.

| | Molecular | | | | | |
|---|---|---|---|---|---|---|
| | weight (mn) | % | % | % | Dw, | Cycles to |
| | kb/mole | Rubber | Bisamide | Siloxane | microns | first crack |
| 1 | 59 | 19 | 1 | 0.25 | 0.33 | 2 |
| 2 | 48 | 17.4 | 3.1 | 0. | 2.9 | 8 |
| 3 | 48 | 12.5 | 2.9 | 0. | 3.35 | 10 |
| 4 | 62 | 13.7 | 4 | 0 | 0.32 | 7 |
| 5 | 57 | 14.0 | 2.3 | 0. | 2.6 | 10 |
| 6 | 70 | 13.7 | 1 | 0. | 0.33 | 10 |
| 7 | 68 | 13.7 | 4 | 0. | 0.32 | 18 |
| 8 | 73 | 13.7 | 4 | 0. | 0.18 | 19 |
| 9 | 70 | 13.7 | 1 | 0.2 | 0.33 | 17 |
| 10 | 57 | 14.0 | 2.3 | 0.2 | 2.6 | 18 |
| 11 | 61 | 12.5 | 4 | 0.2 | 3.42 | 19 |
| 12 | 61 | 12.5 | 4 | 0.2 | 3.42 | 21 |
| 13 | 64 | 13.6 | 4 | 0.2 | 3.07 | 20 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A multilayered structure comprising, in sequence, (i) an ABS layer (ii) a foamed polyurethane layer and (iii) a constraining layer, the surfaces of said (ii) adhering to a surface of said (i) and to a surface of said (iii),
wherein (i) contains a member selected from the group consisting of A and B, where A comprise a first grafted rubber and a first matrix, said first grafted rubber containing a first graft base and a first grafted phase, wherein at least 70 mole % of the structural units of said first graft base are derived from butadiene, and wherein first grafted phase comprise a first copolymer of styrene and acrylonitrile containing 20 to 34 percent of structural units derived from acrylonitrile, the percent being relative to the total weight of the structural units of said first copolymer that are derived from styrene and acrylonitrile, said first matrix containing a second copolymer of styrene and acrylonitrile having a number average molecular weight greater than 65 kg/mole the structural units of said second copolymer containing 20 to 34 percent of structural units derived from acrylonitrile, the percent being relative to the total weight of the structural units of said second copolymer that are derived from styrene and acrylonitrile and at least one additive selected from the group consisting of (1) at least 2 percent relative to the weight of said A of bisamide wax and (2) at least 0.1 percent relative to the weight of said A of di-alkyl siloxane, said first graft base being present in said A in an amount of 10 to 20 percent relative to the weight of A, and
wherein B comprise a second grafted rubber and a second matrix, said second grafted rubber containing a second graft base and a second grafted phase, wherein at least 70 mole % of the structural units of said second graft base are derived from butadiene, and wherein the particle size of said second graft base, determined as weight average particle diameter, is at least 2 microns,
and wherein second grafted phase comprise a third copolymer of styrene and acrylonitrile containing 20 to 34 percent of structural units derived from acrylonitrile, the percent being relative to the total weight of the structural units of said third copolymer that are derived from styrene and acrylonitrile,
and wherein second matrix contains a fourth copolymer of styrene and acrylonitrile having a number average molecular weight greater than 55 kg/mole, said fourth copolymer containing structural units derived from acrylonitrile in an amount of 20 to 34 percent relative to the total weight of the structural units of said fourth copolymer that are derived from styrene and acrylonitrile and
at least 0.1 percent relative to the weight of said B of di-alkyl siloxane, said second graft base being present in said B in an amount of 10 to 20, percent relative to the weight of B,
and wherein (ii) comprise foamed polyurethane the foaming agent used in its preparation is 1,1,1,3,3 pentafluoropropane, said foamed polyurethane having a density of 1.5 to 3 lb/ft3 and thermal conductivity that is no greater than 0.2 BTU-in/hr ft2 F,
and wherein (iii) comprise at least one member selected from the group consisting of metal, plastic and ceramics the physical dimensions and material parameters of which said (iii) calculated to impart to said (i) a stress level of at least 1000 psi.

2. The multilayered structure of claim 1 wherein said (i) is A.

3. The multilayered structure of claim 1 wherein said (i) is B.

4. The multilayered structure of claim 2 wherein the additive is bisamide wax.

5. The multilayered structure of claim 2 wherein the additive is dialkyl siloxane.

6. The multilayered structure of claim 1 wherein the foamed polyurethane layer has a density of 1.5 to 2.5 lb/ft³ and thermal conductivity that is 0.1 to 0.15 BTU-in/hr ft² F.

7. The multilayered structure of claim 2 wherein the foamed polyurethane layer has a density of 1.5 to 2.5 lb/ft³ and thermal conductivity that is 0.1 to 0.15 BTU-in/hr ft² F.

8. The multilayered structure of claim 3 wherein the foamed polyurethane layer has a density of 1.5 to 2.5 lb/ft³ and thermal conductivity that is 0.1 to 0.15 BTU-in/hr ft² F.

9. The multilayered structure of claim 1 wherein the constraining layer is metal.

10. The multilayered structure of claim 9 wherein metal is aluminum.

11. The multilayered structure of claim 10 wherein said (i) is A.

12. The multilayered structure of claim 10 wherein said (i) is B.
